(19) United States
(12) Patent Application Publication
(10) Pub. No.: US 2010/0327627 A1
(43) Pub. Date: Dec. 30, 2010

(54) LIGHT WEIGHT VERTICAL SUPPORT MEMBER IN INSTRUMENT PANEL FRAME

(76) Inventors: Anthony Leanza, Powell, OH (US); Christos Agouridis, JR., Dublin, OH (US); Takashi Nakano, Columbus, OH (US)

Correspondence Address: Emerson, Thomson & Bennett, LLC, 1914 Akron-Peninsula Road, Akron, OH, 44313, US

(21) Appl. No.: 12/494,752

(22) Filed: Jun. 30, 2009

(51) Int. Cl. G12B 9/08; B60J 9/00

(52) U.S. Cl. 296/190.01; 248/27.1

(57) ABSTRACT

A support structure for a vehicle instrument panel frame may be made by: extruding a part having a cross-section that is closed and hollow along a portion of its length; and, forming the part to alter the shape of the cross-section at one or more points along the longitudinal axis of the part.

### I. BACKGROUND OF THE INVENTION

A. Field of Invention

This invention is directed toward an automotive instrument panel frame. More specifically, this invention is directed toward a vertical support structure used with an instrument panel frame and a method of making such a support structure.

B. Description of the Related Art

It is well known in the art to provide automotive vehicles with an instrument panel frame—sometimes referred to as a hanger beam assembly. An instrument panel frame generally is a structural assembly to which a vehicle dashboard is mounted and on which associated components of the vehicle, such as the steering column assembly, navigation and climate control panels, and glove box, are mounted. As such, an instrument panel frame typically extends across the width of the vehicle, between the driver's side and passenger's side A-pillars provided by the vehicle frame.

FIG. 8 shows one example of a known instrument panel frame 1 that includes a driver beam 2 and a main beam 3. Supported to the beams are a driver's side support bracket 4, a pair of steering column support brackets 5, 5, a pair of dashboard knee bolsters 6, 6, a center support bracket 7 and, a passenger's side support bracket 8. The beams are supported to the vehicle floor 9 with a main beam support 10 and a center support 11. A lower support beam 12 may extend between the center support 11 and the passenger's side support bracket 8 in a manner generally parallel to the main beam 3. A stay 13 may extend laterally between the main beam support 10 and the center support 11. A main beam support mounting bracket 14 may also extend laterally between the main beam support 10 and the center support 11 and may be used to connect the instrument panel frame 1 to the floor 9. The components of the instrument panel frame 1 may be formed from aluminum or an aluminum alloy and may be welded and/or bolted together to form a unitary, relatively stiff, structure.

While the instrument panel frame 1 shown in FIG. 8, as well as many other known instrument panel frames, generally work well for their intended purposes, it is desirable to improve upon known instrument panel frames. Specifically it is desirable to produce lighter weight components that are cost effective and that provide manufacturing capability to allow for flexible designs to be used within the relatively complex packaging environment of instrument panel frames.

### II. SUMMARY OF THE INVENTION

According to one embodiment of this invention, a method comprises the steps of: (A) extruding a part having first and second ends, a length, and a longitudinal axis, wherein the part has a cross-section that is closed and hollow along at least 50% of its length; (B) forming the part to alter the shape of the cross-section at a first point along the longitudinal axis of the part; and, (C) preparing the part for use as a support structure for a vehicle instrument panel frame.

According to another embodiment of this invention, an apparatus comprises: a support structure made using the following method: (A) extruding a part having first and second ends, a length, and a longitudinal axis, wherein the part has a cross-section that is closed and hollow along at least 50% of its length; (B) forming the part to alter the shape of the cross-section at a first point along the longitudinal axis of the part; and, (C) preparing the part for use as a substantially vertically oriented support structure for an associated vehicle instrument panel frame.

According to another embodiment of this invention, an instrument panel frame comprises: at least one of a driver beam and a main beam that is generally horizontally oriented and that supports associated vehicle components to an associated vehicle; a first support structure that is generally horizontally oriented and that supports the at least one of the driver beam and the main beam to an associated floor of the associated vehicle; and, wherein the first support structure is made using the following method: (A) extruding a part having first and second ends, a length, and a longitudinal axis, wherein the part has a cross-section that is closed and hollow substantially along its entire length; and, (B) forming the part to alter the shape of the cross-section at a first point along the longitudinal axis of the part.

One advantage of this invention is that the extrusion process and forming operations are cost effective alternatives to other material processing options such as castings or stampings.

Another advantage of this invention is that steering column frequency may be increased.

Another advantage of this invention is that the crash performance of an instrument panel frame may be improved.

Yet another advantage of this invention is that the component mounting rigidity per unit mass for an instrument panel frame may be improved.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a perspective view of an instrument panel frame according to one embodiment of this invention.

FIG. 2 is a close-up perspective view of a support structure shown in FIG. 1.

FIG. 3 is a perspective view of an extruded part that can be formed into the support structure shown in FIG. 2.

FIG. 4 is a sectional view along line 4-4 of FIG. 2.

FIG. 5 is a sectional view along line 5-5 of FIG. 2.

FIG. 6 is a sectional view along line 6-6 of FIG. 2.

FIG. 7 is a sectional view along line 7-7 of FIG. 2.

FIG. 8 is a perspective view of a prior art instrument panel frame.

### IV. DETAILED DESCRIPTION OF THE INVENTION

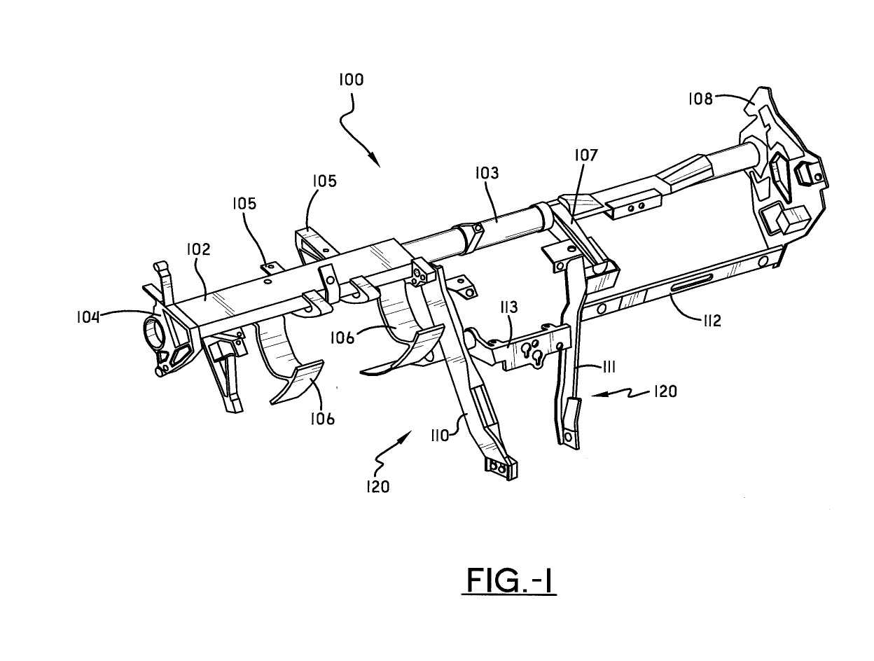

Referring now to the drawings wherein the showings are for purposes of illustrating embodiments of the invention only and not for purposes of limiting the same, and wherein like reference numerals are understood to refer to like components, FIG. 1 shows an instrument panel frame 100 that may include at least one support structure 120 according to this invention. While the instrument panel frame 100 shown is for use in an automobile, it is to be understood that the support structure 120 of this invention will work with instrument panels of any vehicle chosen with the sound judgment of a person of skill in the art including, for some non-limiting examples, trucks, off-the-road vehicles, busses, and boats. The instrument panel frame 100 shown includes a driver beam 102 and a main beam 103. The beams 102, 103 may be parallel and in a more specific embodiment, shown, may be substantially collinear. Supported to the driver beam 102 may be a driver's side support bracket 104, a pair of steering column support brackets 105, 105 and a pair of dashboard knee bolsters 106, 106. Supported to the main beam 103 may be a center support bracket 107 and, a passenger's side support bracket 108.

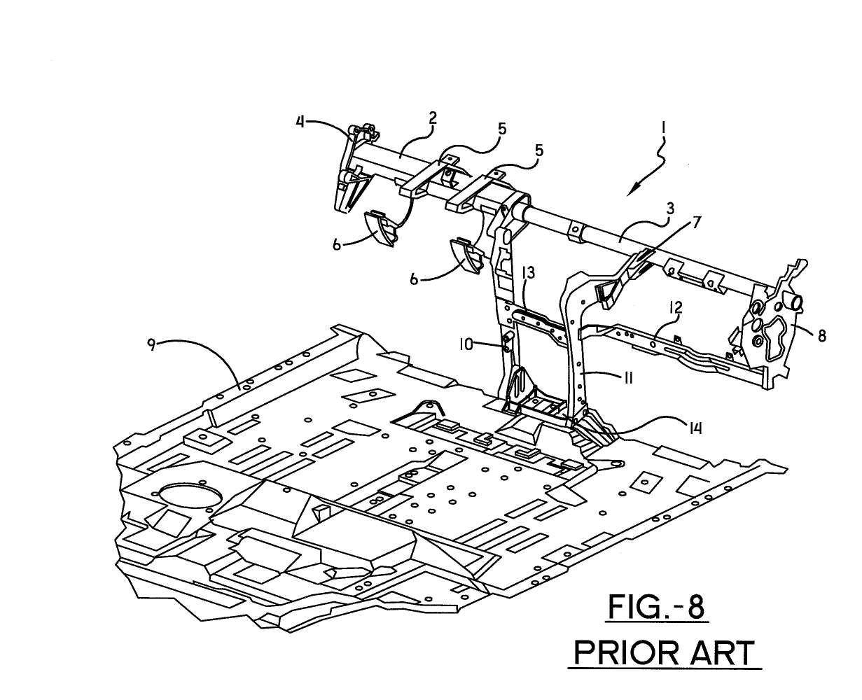

With continuing reference to FIG. 1, the respective beams 102, 103 are supported to the vehicle floor (not shown in FIG. 1 but similar to the floor 9 shown in FIG. 8) with a main beam support 110 and a center support 111. A lower support beam 112 may extend between the center support 111 and the passenger's side support bracket 108 in a manner generally parallel to the main beam 103. A stay 113 may extend laterally between the main beam support 110 and the center support 111. It should be noted that the particular instrument panel frame components just described are exemplary only and are not intended to limit this invention in any way. As one example, a main beam support mounting bracket, not shown or required for the embodiment shown in FIG. 1, may be used in a manner similar to the main beam support mounting bracket 14 shown in FIG. 8 and discussed above. It should also be noted that the use and manufacture of instrument panel frame components are well known to those of skill in the art so details will not be provided here. However, Applicant hereby references U.S. Pat. No. 7,377,578 titled HANGER BEAM ASSEMBLY which has a common assignee and which is hereby fully incorporated by reference into this patent.

Still referring to FIG. 1, prior to describing the manner of making a support structure 120 according to this invention, it should be noted that any number of instrument panel frame components chosen with the sound judgment of a person of skill in the art may be formed as a support structure 120. Applicants have discovered, however, that the benefits of this invention are especially realized when an instrument panel frame component that bears a relatively significant compression load is formed as a support structure 120. Such significant compression loads are generally applied to instrument panel frame components that have a substantially vertically orientation. Thus, in one specific embodiment, either one of the main beam support 110 or the center support 111 may be made to be a support structure 120. In another embodiment, both of the main beam support 110 and the center support 111 may be made to be support structures 120. In yet another embodiment, not shown, the instrument panel frame 100 may only require one vertically oriented instrument panel frame component and it is made to be a support structure 120.

With reference now to FIGS. 1-7, a support structure 120 may be made by taking the following steps: (A) extruding a part 200 to have a cross-section that is closed and hollow along at least 50% of its length L; (B) forming the part 200 to alter the shape of the cross-section at at least one point along the longitudinal axis A-A of the part 200; and, (C) preparing the part 200 for use as a support structure 120 for a vehicle instrument panel frame 100. These steps will now be described in more detail.

With reference to FIG. 3, the part may be formed of any material or 25 combination of materials chosen with the sound judgment of skill in the art. In one embodiment, the material is aluminum. In another embodiment, the material is an aluminum alloy. In yet another embodiment, the material is another relatively light weight material that can be extruded to have a closed and hollow cross-section along at least 50% of its length. The part 200, after having been extruded, is shown in FIG. 3. As the extrusion process is well known to those of skill in the art, details will not be provided here. As shown, the part 200 has first and second ends 202, 204, a length L and a longitudinal axis A-A. The part 200 shown has a closed and hollow cross-section along its entire length L. By “closed” it is meant that the cross-section is continuous about its perimeter without an opening. By “hollow” it is meant that the cross-section has a space or cavity on the inside of the perimeter. The first end 202 of the part 200 shown in FIG. 3, for example, has a continuous perimeter 206 and has a cavity 208 within the perimeter 206. While the embodiment shown in FIG. 3 has a closed and hollow cross-section along its entire length L, it should be understood that in alternate embodiments less than the entire length may have a closed and hollow cross-section. Also, while the embodiment shown in FIG. 3 has a rectangular shaped cross-section of the same size along its entire length L, it should be understood that in alternate embodiments other cross-sectional shapes may be used and the shape (or shapes) can vary in size along the length L of the part 200.

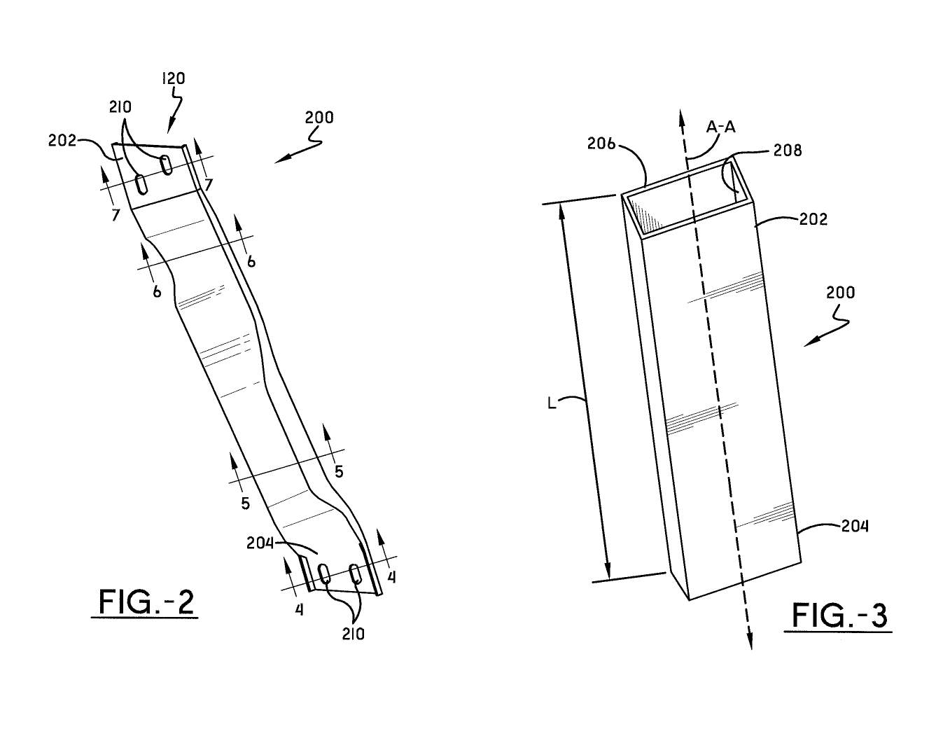

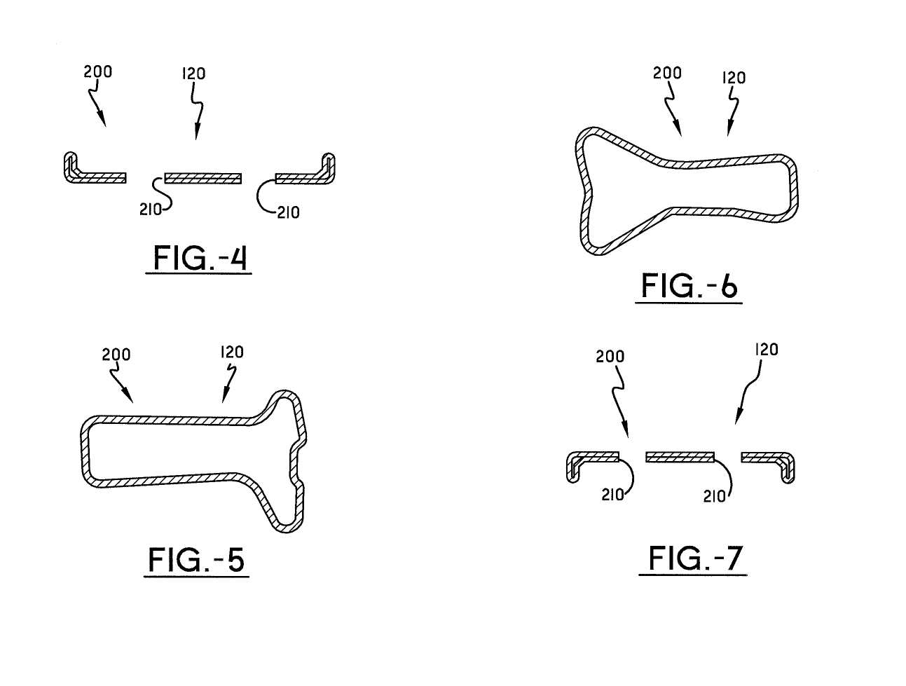

With reference now to FIGS. 2-7, after being extruded, the part 200 may be formed to alter its extruded shape as required for its particular application in the instrument panel frame 100. The manner of forming the part 200 can be any chosen with the sound judgment of a person of skill in the art. In one non-limiting embodiment, the part 200 may be formed using a mechanical stamping process. As the mechanical stamping process is well known to those of skill in the art, details will not be provided here. It may be required to alter the shape of the cross-section at one or more points along the longitudinal axis A-A of the part 200. FIG. 2 shows the part 200 from FIG. 3 after it has been formed, according to one embodiment of this invention. Note that the original cross-sectional shape (shown in FIG. 3) has been significantly altered during the forming step. The altered cross-sectional shapes are shown specifically at four points along the longitudinal axis A-A as shown in FIGS. 2 and 4-7. The altered cross-sectional shapes at both section 4-4 (shown in FIG. 4) and section 7-7 (shown in FIG. 7) have the hollowness substantially removed. The altered cross-sectional shape at section 4-4 (shown in FIG. 4) has outer edges extending upward while the altered cross-sectional shape at section 7-7 (shown in FIG. 7) has outer edges extending downward. The altered cross-sectional shape at section 5-5 (shown in FIG. 5) has a relatively larger thickness on the right hand side while the altered cross-sectional shape at section 6-6 (shown in FIG. 6) has a relatively larger thickness on the left hand side. It should be understood that these specific altered cross-sectional shapes are exemplary only as any alteration chosen with the sound judgment of a person of skill in the art will work well with this invention.

With reference to FIGS. 1-7, also after being extruded, the part 200 may be pierced to form piercings 210 to allow the support structure 120 to be bolted to the instrument panel frame 100 and/or to the vehicle floor. The piercings 210 may be formed in any manner, in any number, and in any location chosen with the sound judgment of a person of skill in the art. The piercings may be formed, in some non-limiting examples, with a mechanical piercing device or with a laser cutting device. As the operation of such devices is well known to those of skill in the art, details will not be provided here. For the embodiment shown in FIGS. 2, 4 and 7, a pair of piercings 210 has been formed on opposite ends of the part 200. After the part 200 has been extruded and formed, it may undergo any final processing steps, such as grinding, cleaning, painting, etc. to prepare it for use as a support structure 120. Once prepared, the support structure 120 can be assembled to the instrument panel frame 100 in any manner chosen with the sound judgment of a person of skill in the art.

Numerous embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

1. A method comprising the steps of:
(A) extruding a part having first and second ends, a length, and a longitudinal axis, wherein the part has a cross-section that is closed and hollow along at least 50% of its length;
(B) forming the part to alter the shape of the cross-section at a first point along the longitudinal axis of the part; and,
(C) preparing the part for use as a support structure for a vehicle instrument panel frame.

2. The method of claim 1 wherein step (A) comprises the step of:
extruding the part to have a cross-section that is closed and hollow substantially along its entire length.

3. The method of claim 1 wherein step (A) comprises the step of:
extruding the part where the cross-section that is closed and hollow to have a substantially rectangular shape.

4. The method of claim 1 wherein step (A) comprises the step of:
extruding the part substantially out of aluminum.

5. The method of claim 1 wherein step (B) further comprises the step of:
forming the part to alter the shape of the cross-section at a second point along the longitudinal axis of the part spaced from the first point, wherein the altered shape of the cross-section at the second point is substantially different from the altered shape of the cross-section at the first point.

6. The method of claim 1 wherein step (B) comprises the step of:
altering the shape of the cross-section at the first point to substantially remove the hollowness.

7. The method of claim 1 wherein step (B) comprises the step of:
using a mechanical stamping process to alter the shape of the cross-section at the first point.

8. The method of claim 1 further comprising the step of:
(D) using the part as a support structure for the vehicle instrument panel frame.

9. The method of claim 8 wherein:
prior to step (D) the method comprises the step of: piercing the first end of the part; and,
step (D) comprises the steps of: positioning the part into the support structure for the vehicle instrument panel frame in a substantially vertical orientation; and, bolting the part to a vehicle floor component through the piercing.

10. An apparatus comprising:
a support structure made using the following method:
(A) extruding a part having first and second ends, a length, and a longitudinal axis, wherein the part has a cross-section that is closed and hollow along at least 50% of its length;
(B) forming the part to alter the shape of the cross-section at a first point along the longitudinal axis of the part; and,
(C) preparing the part for use as a substantially vertically oriented support structure for an associated vehicle instrument panel frame.

11. The apparatus of claim 10 wherein the part when extruded has a cross-section that is closed and hollow along its entire length.

12. The apparatus of claim 10 wherein the part is formed of aluminum.

13. The apparatus of claim 1 wherein:
the part is formed to have an altered shape of the cross-section at a second point along the longitudinal axis of the part spaced from the first point; and,
the altered shape of the cross-section at the second point is substantially different from the altered shape of the cross-section at the first point.

14. The apparatus of claim 13 wherein:
the altered shape of the cross-section at the first point is substantially not hollow.

15. The apparatus of claim 14 wherein:
the part is formed to have an altered shape of the cross-section at a third point along the longitudinal axis of the part spaced from the first and second points; and,
the altered shape of the cross-section at the third point is substantially different from the altered shape of the cross-section at the first and second points.

16. The apparatus of claim 15 wherein:
each of the first and second ends of the support structure have at least one piercing for use in receiving an associated bolt.

17. An instrument panel frame comprising:
at least one of a driver beam and a main beam that is generally horizontally oriented and that supports associated vehicle components to an associated vehicle;
a first support structure that is generally horizontally oriented and that supports the at least one of the driver beam and the main beam to an associated floor of the associated vehicle; and,
wherein the first support structure is made using the following method:
(A) extruding a part having first and second ends, a length, and a longitudinal axis, wherein the part has a cross-section that is closed and hollow substantially along its entire length; and,
(B) forming the part to alter the shape of the cross-section at a first point along the longitudinal axis of the part.

18. The instrument panel frame of claim 17 wherein:
the part is formed to have an altered shape of the cross-section at a second point along the longitudinal axis of the part spaced from the first point; and,
the altered shape of the cross-section at the second point is substantially different from the altered shape of the cross-section at the first point.

19. The instrument panel frame of claim 18 wherein:
the instrument panel frame comprises: a driver beam that is generally horizontally oriented and that supports an associated steering column support bracket to an associated vehicle; and, a main beam that is generally horizontally oriented and that supports an associated center support bracket to the associated vehicle;
the first support structure is formed using a mechanical stamping process to alter the shape of the cross-section at the first and second points;
the first support structure supports the driver beam to the associated floor of the associated vehicle;
the instrument panel frame further comprises: a second support structure that is generally horizontally oriented and that supports the main beam to the associated floor of the associated vehicle; and,
wherein the second support structure is made using the following method:
(A) extruding a part having first and second ends, a length, and a longitudinal axis, wherein the part has a cross-section that is closed and hollow substantially along its entire length; and,
(B) using a mechanical stamping process to form the part to alter the shape of the cross-section at a first point along the longitudinal axis of the part;
(C) using a mechanical stamping process to form the part to alter the shape of the cross-section at a second point along the longitudinal axis of the part that is spaced from the first point; and,
(D) wherein the altered shape of the cross-section at the second point is substantially different from the altered shape of the cross-section at the first point.

20. The instrument panel frame of claim 19 wherein:
the part used to make the first support structure: is formed using a mechanical stamping process to have an altered shape of the cross-section at a third point along the longitudinal axis of the part spaced from the first and second points that is substantially different from the altered shape of the cross-section at the first and second points;
the part used to make the second support structure: is formed using a mechanical stamping process to have an altered shape of the cross-section at a third point along the longitudinal axis of the part spaced from the first and second points that is substantially different from the altered shape of the cross-section at the first and second points;
the altered shape of the cross-section of the part used to make the first support structure at the first point is not hollow;
the altered shape of the cross-section of the part used to make the second support structure at the first point is not hollow;
each of the first and second ends of the first support structure have at least one piercing for use in receiving an associated bolt; and,
each of the first and second ends of the second support structure have at least one piercing for use in receiving an associated bolt.
